(19) United States
(12) Patent Application Publication
(10) Pub. No.: US 2020/0412821 A1
(43) Pub. Date: Dec. 31, 2020

(54) METHOD AND SYSTEM FOR OPTIMIZED ONLINE PRESENCE TRACKING

(71) Applicant: Synchronoss Technologies, Inc., Bridgewater, NJ (US)

(72) Inventor: Alec Lazarescu, Fanwood, NJ (US)

(21) Appl. No.: 16/455,893

(22) Filed: Jun. 28, 2019

(51) Int. Cl. H04L 29/08; H04L 29/06

(52) U.S. Cl. CPC H04L 67/24; H04L 67/18; H04L 67/02; H04L 67/42

(57) ABSTRACT

A computer implemented method and apparatus for optimized online presence tracking. The method comprises receiving, from a user device, a request to open a communication connection; in response to receiving the request, opening the communication connection using a native communication protocol function; receiving a message from the user device comprising data that identifies a desired presence level; and in response to receiving the message, upserting presence tracking information to a cache server for use by one or more interested servers.

### BACKGROUND OF THE INVENTION

### Field of the Invention

Embodiments of the present invention generally relate to presence tracking, and more specifically to a method and system for optimized online presence tracking through WebSocket properties.

### Description of the Related Art

Websites and software applications often track the presence of an online user so they may target for example, messages or ad campaigns to the online user when the presence tracker indicates the user is online.

Typical presence trackers may easily be blocked by user using, for example an ad blocker and block cookies, etc. When a marketer performs an expensive operation such as uploading new image or ad campaign to a user when the user is not online, the marketer wastes valuable resources. In addition, it would be helpful to the marketer to know the user's behavior over time so the marketer can anticipate when the user will be online in the future and schedule operations to the user during a time the marketer can presume the user is online.

Other presence tracking systems are not based on native support and therefore require extra pieces to maintain, often clutter log files, and/or may inadvertently be blocked by browser, security, or add-ons.

Therefore, there is a need for optimized online presence tracking.

### SUMMARY OF THE INVENTION

An apparatus and/or method is provided for optimized online presence tracking substantially as shown in and/or described in connection with at least one of the figures.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 depicts a block diagram of a system for optimized online presence tracking, according to one or more embodiments of the invention;

FIG. 2 depicts a flow diagram of a method for an optimized online presence tracking, according to one or more embodiments of the invention; and

FIG. 3 depicts a computer system that can be utilized in various embodiments of the present invention to implement the computer and/or the display, according to one or more embodiments of the invention.

While the method and apparatus is described herein by way of example for several embodiments and illustrative drawings, those skilled in the art will recognize that the method and apparatus for optimized online presence tracking is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for optimized online presence tracking defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for a system and method for optimized online presence tracking, according to embodiments of the invention. A client device connects with a WebSocket server. The client requests a WebSocket connection with the WebSocket server, which in turn sends back an acknowledgement (e.g., a PING message) to the client device. At this point there is a bi-directional connection that remains open for messaging. The client transmits a PONG message back to the WebSocket server. The PONG frames carry a payload of data consisting of a context identifying the presence level desired. For example, the presence level may be for a single user in order to monitor the presence of said user. Alternatively, the presence level may be for an organization to monitor the presence of anyone from the organization. The WebSocket server receives the PONG frame and obtains the context from the payload. The WebSocket server upserts presence tracker information to a cache server. As known in the art, upserting means update or inserting, whichever is applicable. IN other words, the information is inserting the presence information in the cache server if none exists for the user, and updated if presence information for the user already exists. Other backend servers may make access requests to the cache server to check the presence of a user and make use of the returned presence information for example, for showing status on a user display, calculation, or optimization of certain processes when users are not online.

The best tracking systems are those that are less likely to stand out and be blocked. Advantageously, the present invention piggy backs on native WebSocket frames and is therefore less likely to be detected or blocked, intentionally or unintentionally. The present invention further avoids cluttered log files and inadvertent blocking by browsers, security, and add-ons. As such, the present invention may be used for showing end users the presence of others, showing an operations team the presence of its users, optimizing certain operations so the operations would not be performed if a user is not present and would not benefit from the operation, thereby saving computing time and resources. Lastly, data collection can show the times a user is online, which allows for capacity planning as well as more effective campaigns and marketing automation when users are likely to be online.

Various embodiments of a method and apparatus for optimized online presence tracking are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. Although the present application describes the invention using drone controllers in communication with target devices, one skilled in the art will appreciate that any the present invention may be implemented on specific or general purpose computers (e.g., cloud servers) that communicate with devices.

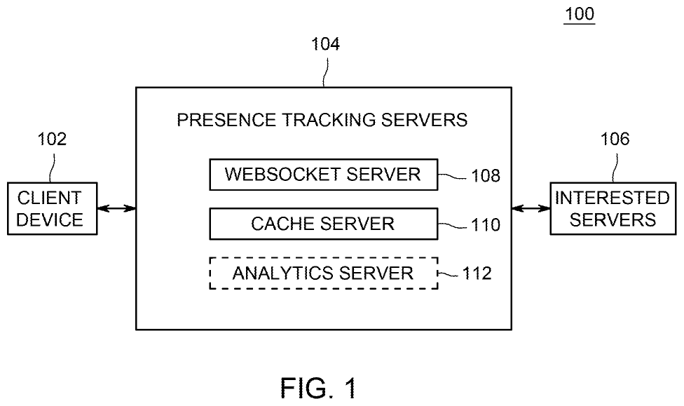

FIG. 1 depicts a block diagram of a system 100 for optimized online presence tracking, according to one or more embodiments of the invention. The system 100 includes a client device 102, a plurality of presence tracking servers 104, which include a WebSocket server 108, a cache server 110, and an analytics server 112. The system 100 further includes various interested servers 106 that connect to the cache server 110 to retrieve presence information. In some embodiments, the WebSocket server 108, the cache server 110, and the analytics server 112 are part of a single presence tracking server. In some embodiments, the WebSocket server 108, the cache server 110, and the analytics server 112 are independent servers accessible by the various interest servers 106. One skilled in the art will appreciate that any configuration of the servers in the present invention may be implemented and further that the analytics server 112 may be optional and the long-term details and trends regarding the presence state of one or more individuals may be stored elsewhere. The client device 102 may include a browser, a mobile application, or any other WebSocket initiating service. The WebSocket server 108 handles termination of WebSocket connections and updating presence tracking into the cache server 110 so the information may be used by the various interested servers 106. The cache server 110 supports a time to live (TTL) based expiration system so objects can be automatically purged. The various interested servers 106 can make use of the presence information on the cache server 110.

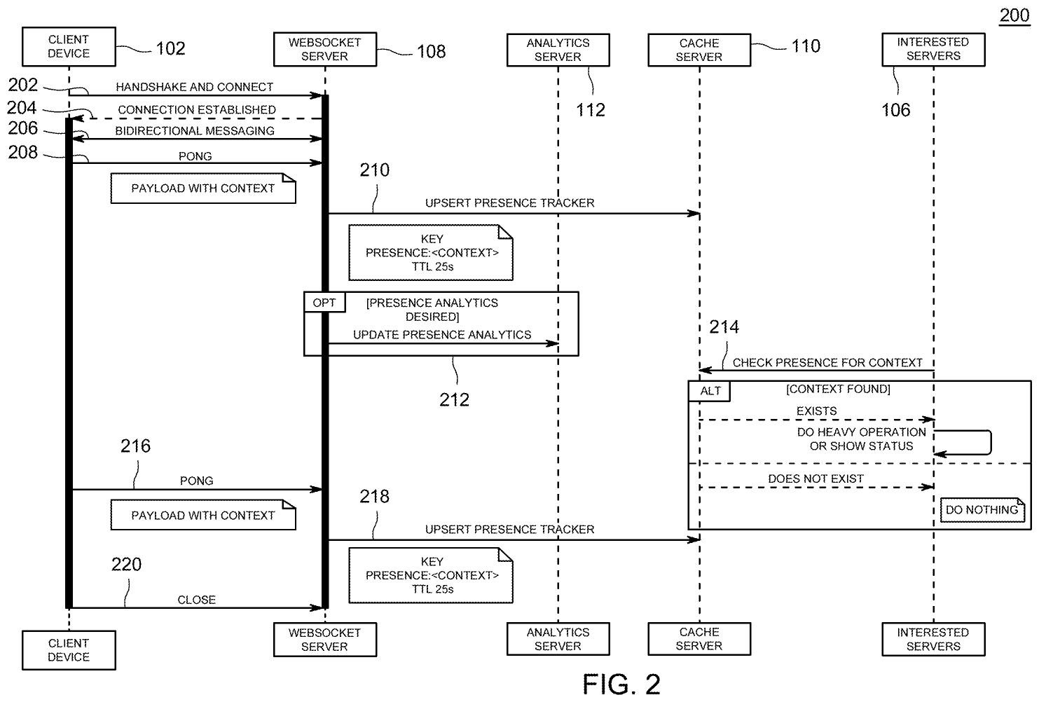

FIG. 2 depicts a flow diagram of a method 200 for optimized online presence tracking, according to one or more embodiments of the invention.

The method 200 starts at step 202 where a client device requests a WebSocket connection with the WebSocket server. At step 204, the WebSocket server sends back an acknowledgement to the client device. Once the acknowledgement is received, at step 206, a bi-directional connection is open and remains open for messaging until the WebSocket closes the connection. At step 208, the client transmits a PONG message back to the WebSocket server. The PONG frames carry a payload of data consisting of a context identifying the presence level desired. For example, the presence level may be for a single user using a user identifier in the form presence:<userID>. Alternatively, the presence level may be for an organization to monitor a hierarchy presence of anyone from the organization. In such case the data may include and organization identifier, an account identifier, as well as a user identifier, for example presence:<organizationID>:<accountID>:<userID>. The WebSocket server receives the PONG frame and obtains the context from the payload. At step 210, the WebSocket server upserts presence tracker information to the cache server based on the information passed in the PONG frames. Optionally, if analytics are being tracked to analyze long-term details and trends to identify for example, when a user is normally online, at step 212, the WebSocket server updates presence analytics on the analytics server. At step 214, other backend servers may access the cache server to check the presence of a user. In the case of a hierarchy presence, the backend servers may determine whether a particular user is online, whether anyone from the account is online, or if anyone from the entire organization online. The presence information may be used to for example, for showing status on a user display, or ensuring a user is online before executing an operation that involves a significant amount of computing resources, such as uploading a marketing campaign, and the like. The method continues for example, at step 216, the client device may send a second PONG frame with new context that at step 218 is processed by the WebSocket server; the presence information upserted to the cache server. Although only two PONG messages are shown, the WebSocket can continue for minutes or hours resulting in possibly thousands of PING/PONG messages. The method iterates until at step 220, the connection between the client device and the WebSocket Server closes.

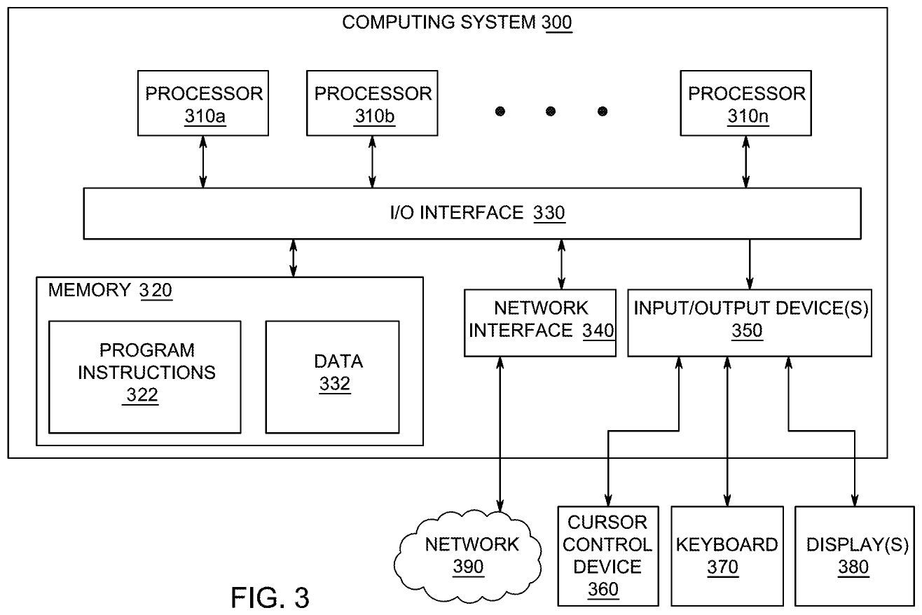

FIG. 3 depicts a computer system that can be used to implement the method of FIG. 2 in various embodiments of the present invention, according to one or more embodiments of the invention.

Various embodiments of method and apparatus for optimized online presence tracking, as described herein, may be executed on one or more computer systems, which may interact with various other devices. One such computer system is computer system 300 illustrated by FIG. 3, which may in various embodiments implement any of the elements or functionality illustrated in FIGS. 1-2. In various embodiments, computer system 300 may be configured to implement methods described above. The computer system 300 may be used to implement any other system, device, element, functionality or method of the above-described embodiments. In the illustrated embodiments, computer system 300 may be configured to implement method 200, as processor-executable executable program instructions 322 (e.g., program instructions executable by processor(s) 310) in various embodiments.

In the illustrated embodiment, computer system 300 includes one or more processors 310 coupled to a system memory 320 via an input/output (I/O) interface 330. Computer system 300 further includes a network interface 340 coupled to I/O interface 330, and one or more input/output devices 350, such as cursor control device 360, keyboard 370, and display(s) 380. In various embodiments, any of components may be utilized by the system to receive user input described above. In various embodiments, a user interface (e.g., user interface) may be generated and displayed on display 380. In some cases, it is contemplated that embodiments may be implemented using a single instance of computer system 300, while in other embodiments multiple such systems, or multiple nodes making up computer system 300, may be configured to host different portions or instances of various embodiments. For example, in one embodiment some elements may be implemented via one or more nodes of computer system 300 that are distinct from those nodes implementing other elements. In another example, multiple nodes may implement computer system 300 in a distributed manner.

In different embodiments, computer system 300 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 300 may be a uniprocessor system including one processor 310, or a multiprocessor system including several processors 310 (e.g., two, four, eight, or another suitable number). Processors 310 may be any suitable processor capable of executing instructions. For example, in various embodiments processors 310 may be general-purpose or embedded processors implementing any of a variety of instruction set architectures (ISAs), such as the x96, PowerPC, SPARC, or MIPS ISAs, or any other suitable ISA. In multiprocessor systems, each of processors 310 may commonly, but not necessarily, implement the same ISA.

System memory 320 may be configured to store program instructions 322 and/or data 332 accessible by processor 310. In various embodiments, system memory 320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 320. In other embodiments, program instructions and/or data may be received, sent or stored upon different types of computer-accessible media or on similar media separate from system memory 320 or computer system 300.

In one embodiment, I/O interface 330 may be configured to coordinate I/O traffic between processor 310, system memory 320, and any peripheral devices in the device, including network interface 340 or other peripheral interfaces, such as input/output devices 350, In some embodiments, I/O interface 330 may perform any necessary protocol, timing or other data transformations to convert data signals from one components (e.g., system memory 320) into a format suitable for use by another component (e.g., processor 310). In some embodiments, I/O interface 330 may include support for devices attached through various types of peripheral buses, such as a variant of the Peripheral Component Interconnect (PCI) bus standard or the Universal Serial Bus (USB) standard, for example. In some embodiments, the function of I/O interface 330 may be split into two or more separate components, such as a north bridge and a south bridge, for example. Also, in some embodiments some or all of the functionality of I/O interface 330, such as an interface to system memory 320, may be incorporated directly into processor 310.

Network interface 340 may be configured to allow data to be exchanged between computer system 300 and other devices attached to a network (e.g., network 390), such as one or more external systems or between nodes of computer system 300. In various embodiments, network 390 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 340 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 350 may, in some embodiments, include one or more display terminals, keyboards, keypads, touch pads, scanning devices, voice or optical recognition devices, or any other devices suitable for entering or accessing data by one or more computer systems 300. Multiple input/output devices 350 may be present in computer system 300 or may be distributed on various nodes of computer system 300. In some embodiments, similar input/output devices may be separate from computer system 300 and may interact with one or more nodes of computer system 300 through a wired or wireless connection, such as over network interface 340.

In some embodiments, the illustrated computer system may implement any of the methods described above, such as the methods illustrated by the flowchart of FIG. 2. In other embodiments, different elements and data may be included.

Those skilled in the art will appreciate that computer system 300 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, etc. Computer system 300 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 300 may be transmitted to computer system 300 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, etc.), ROM, etc.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method for online presence tracking, comprising:
receiving, from a user device, a request to open a communication connection;
in response to receiving the request, opening the communication connection using a native communication protocol function;
receiving a message from the user device comprising data that identifies a desired presence level; and
in response to receiving the message, upserting presence tracking information to a cache server for use by one or more interested servers.

2. The method of claim 1, wherein the native communication protocol is a WebSocket protocol.

3. The method of claim 1, wherein the desired presence level is received in a PONG message frame.

4. The method of claim 1, wherein the desired presence level is for an individual user to be tracked.

5. The method of claim 1, wherein the desired presence level is for a hierarchy, wherein a presence of any user within the hierarchy is tracked.

6. The method of claim 1, further comprising updating long-term details and trends on a state of a user presence on an analytics server.

7. A system for optimized online presence tracking, comprising:
a) at least one processor;
b) at least one input device; and
c) at least one storage device storing processor-executable instructions which, when executed by the at least one processor, perform a method including:
receiving, from a user device, a request to open a communication connection;
in response to receiving the request, opening the communication connection using a native communication protocol function;
receiving a message from the user device comprising data that identifies a desired presence level; and
in response to receiving the message, upserting presence tracking information to a cache server for use by one or more interested servers.

8. The system of claim 7, further comprising:
updating long-term details and trends on a state of a user presence on an analytics server.

9. The system of claim 7, wherein the native communication protocol is a WebSocket protocol.

10. The system of claim 7, wherein the desired presence level is received in a PONG message frame.

11. The system of claim 7, wherein the desired presence level is for an individual user to be tracked.

12. The system of claim 7, wherein the desired presence level is for a hierarchy, wherein a presence of any user within the hierarchy is tracked.

13. A non-transitory computer readable medium for storing computer instructions that, when executed by at least one processor causes the at least one processor to perform a method for online presence tracking, comprising:
receiving, from a user device, a request to open a communication connection;
in response to receiving the request, opening the communication connection using a native communication protocol function;
receiving a message from the user device comprising data that identifies a desired presence level; and
in response to receiving the message, upserting presence tracking information to a cache server for use by one or more interested servers.

14. The non-transitory computer readable medium of claim 13, further comprising:
updating long-term details and trends on a state of a user presence on an analytics server.

15. The non-transitory computer readable medium of claim 13, wherein the native communication protocol is a WebSocket protocol.

16. The non-transitory computer readable medium of claim 13, wherein the desired presence level is received in a PONG message frame.

17. The non-transitory computer readable medium of claim 13, wherein the desired presence level is for an individual user to be tracked.

18. The non-transitory computer readable medium of claim 13, wherein the desired presence level is for a hierarchy, wherein a presence of any user within the hierarchy is tracked.
